(19) United States
(12) Patent Application Publication
(10) Pub. No.: US 2026/0040308 A1
(43) Pub. Date: Feb. 5, 2026

(54) Methods for Reward Signal Design and Handling for UE-sided Reinforcement Learning

(71) Applicant: InterDigital Patent Holdings, Inc., Wilmington, DE (US)

(72) Inventors: Ahmet Serdar Tan, London (GB); Yugeswar Deenoo Narayanan Thangaraj, Chalfont, PA (US); Mohamed Salah Ibrahim, Chesterbrook, PA (US); Mihaela Beluri, Jericho, NY (US)

(73) Assignee: InterDigital Patent Holdings, Inc., Wilmington, DE (US)

(21) Appl. No.: 18/790,824

(22) Filed: Jul. 31, 2024

(51) Int. Cl. H04W 72/20; H04L 41/16

(52) U.S. Cl. CPC H04W 72/20; H04L 41/16

(57) ABSTRACT

An example Wireless Transmit/Receive Unit (WTRU) includes a processor. The processor is configured to receive configuration information. The configuration information comprises an indication of an exploration rate for operating according to an exploration mode or an exploitation mode, and an indication of a reward type. The processor is configured to send an indication of a first action associated with the exploitation mode, receive an out-of-range (OOR) indication and an indication of a reward signal associated with the reward type, send a request associated with the exploration mode based on the reward signal being less than a threshold and the OOR indication indicating that an OOR condition is not detected, and adjust one or more actions to be performed by the WTRU based on the reward signal being less than the threshold and the OOR indication indicating that the OOR condition is detected.

### BACKGROUND

The Reinforcement Learning (RL) framework consists of two key components, e.g., agent and environment. The agent may be a machine learning (ML) algorithm, and the environment may be an adaptive problem space that the agent interacts with.

### SUMMARY

An example Wireless Transmit/Receive Unit (WTRU) is disclosed that includes a processor. The processor is configured to receive configuration information (e.g., for a RL model). The configuration information comprises an indication of an exploration rate for operating according to an exploration mode or an exploitation mode. The configuration information further comprises an indication of a reward type for reward signals (e.g., associated with training the RL model). The processor is further configured to send an indication of a first action associated with the exploitation mode. The processor is further configured to receive an out-of-range (OOR) indication and an indication of a reward signal associated with the reward type. The processor is further configured to send a request associated with the exploration mode based on the reward signal being less than a threshold and the OOR indication indicating that an OOR condition is not detected. The processor is further configured to adjust one or more actions to be performed by the WTRU based on the reward signal being less than the threshold and the OOR indication indicating that the OOR condition is detected.

In examples, the reward type is associated with an acknowledgement or negative acknowledgement (ACK/NACK) indication. In examples, the reward type is associated with a beam indication. In examples, the processor is configured to, in response to a beam failure detection (BFD), delay or prevent a beam failure recovery (BFR) action associated with the BFD to adjust the one or more actions. In examples, the processor is configured to, in response to a decoding failure, send an acknowledgement (ACK) indication to adjust the one or more actions comprises. In examples, the indication is received via one or more of physical downlink shared channel (PDSCH) configuration information, an acknowledgement or negative acknowledgement (ACK/NACK) indication, a hybrid automatic repeat request (HARQ), or downlink control information (DCI).

An example method performed by a WTRU is disclosed. The method comprises receiving configuration information (e.g., for a RL model). The configuration information comprises an indication of an exploration rate for operating according to an exploration mode or an exploitation mode. The configuration information further comprises an indication of a reward type for reward signals (e.g., associated with training the RL model). The method further comprises sending an indication of a first action associated with the exploitation mode. The method further comprises receiving an OOR indication and an indication of a reward signal associated with the reward type. The method further comprises sending a request associated with the exploration mode based on the reward signal being less than a threshold and the OOR indication indicating that an OOR condition is not detected; or adjusting one or more actions to be performed by the WTRU based on the reward signal being less than the threshold and the OOR indication indicating that the OOR condition is detected.

In examples, the reward type is associated with an ACK/NACK indication. In examples, the reward type is associated with a beam indication. In examples, adjusting the one or more actions comprises delaying or preventing a BFR action associated with a BFD in response to the BFD. In examples, adjusting the one or more actions comprises sending an ACK indication in response to a decoding failure. In examples, the indication is received via one or more of PDSCH configuration information, an ACK/NACK indication, a HARQ, or DCI. In examples, the method further comprises determining the reward signal based on the received one or more of the PDSCH configuration information, the ACK/NACK indication, the HARQ, or the DCI. In examples, the request comprises a request to enter the exploration mode. In examples, the request comprises an indication of a second action associated with the exploration mode. In examples, sending the indication of the first action comprises sending an indication of one or more channel quality parameters, wherein the one or more channel quality parameters include one or more of a channel quality indicator (CQI) or a rank indicator (RI). In examples, sending the indication of the first action comprises sending an indication of one or more beam selection parameters. In examples, the method further comprises activating training of the RL model, wherein sending the indication of the first action is based on the training of the RL model being activated. In examples, the method further comprises receiving an activation command, wherein activating the training of the RL model is in response to receiving the activation command. In examples, the method further comprises determining whether to deactivate training of the RL model based on the reward signal being greater than the threshold.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example of an RL framework, according to an embodiment.

### DETAILED DESCRIPTION

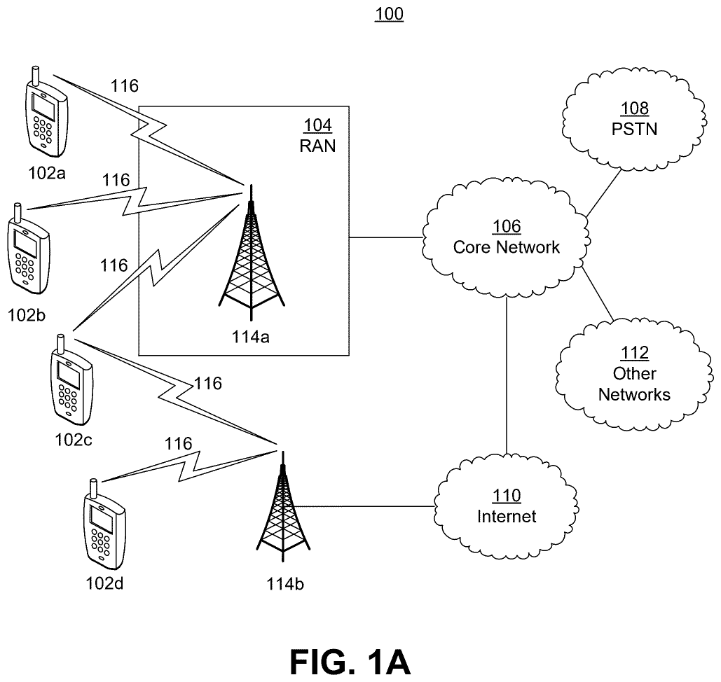

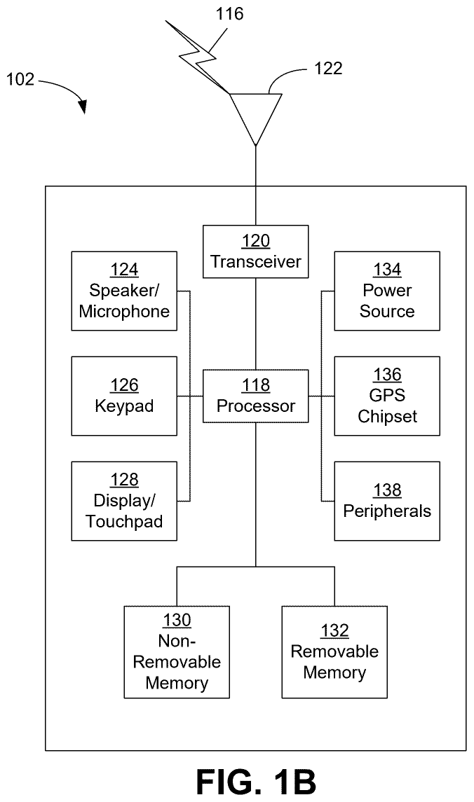

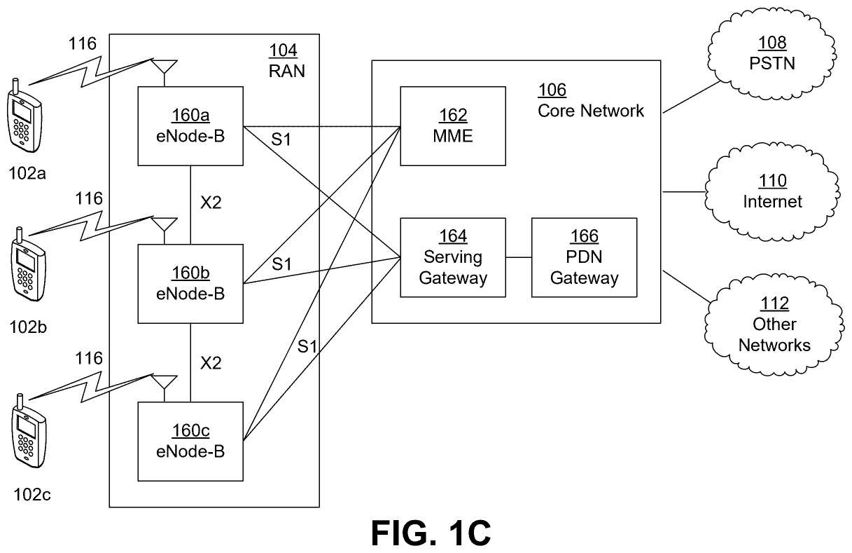

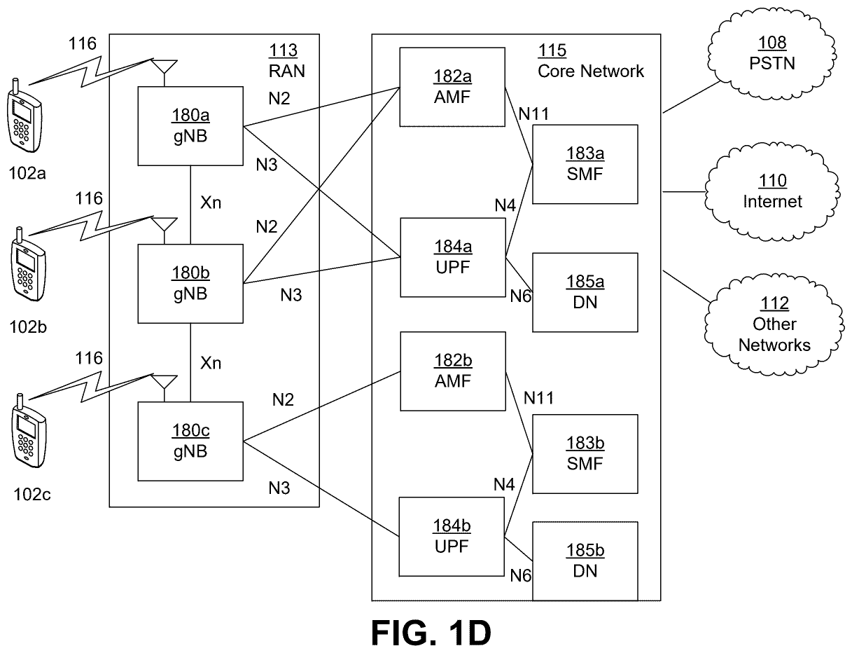

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

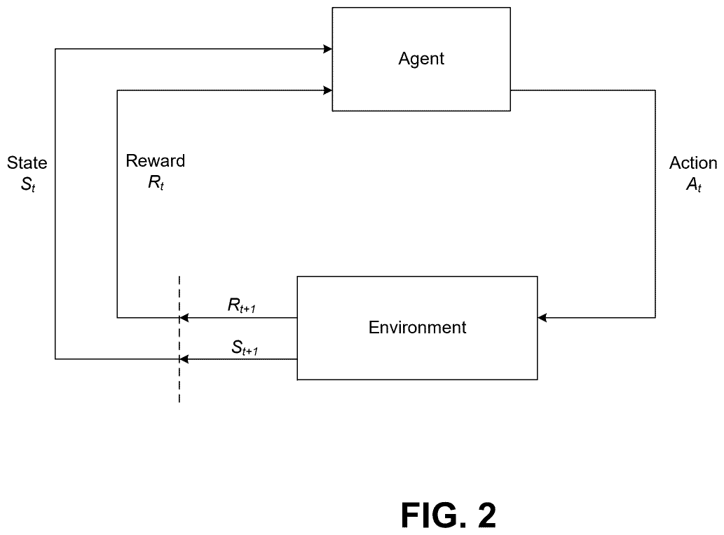

An illustration of how a RL framework works is shown in FIG. 2. The agent decides on an action Aₜ at time step t based on the current state Sₜ using its RL policy π(A, S) which represents the mapping from perceived states to actions to be taken when in those states. Then, the environment executes the action and returns a reward Rₜ₊₁ and next state Sₜ₊₁. Using the information (e.g., state, action, reward, next state) collected over past steps, the agent updates its policy to maximize the cumulative reward.

RL models can be trained in different ways, either online wherein the agent interacts with the environment in real time during training the RL model, or offline wherein the RL agent uses a dataset or an emulation of the environment. In the RL agent training process, the agent can either exploit (e.g., use the best action from the current policy) or explore (e.g., try new or random actions). Exploration is key for the training of an RL agent where the agent interacts with the environment to find out better rewards. In online training, the RL agent may start from a blank (e.g., random) policy or an offline trained policy.

The examples described herein may enable online learning for WTRU-sided RL models. WTRU-sided online RL models may be configured to learn an optimal or improved policy for exploitation actions by interacting with an environment. For example, the learning process includes exploration actions where a WTRU may need to take random actions to learn (e.g., to update the exploitation policy) from the response (e.g., rewards) of the environment. One of the challenges is handling the reward in a network (NW) controlled training and inference loop for a WTRU-sided online RL model. Some examples herein include a WTRU configured to determine and handle the reward in a WTRU sided online RL mechanism.

The WTRU capable of online training an RL model may receive configuration information including an indication of reward types and/or WTRU behavior(s). The WTRU may determine and report back an action determined with RL modes. The WTRU may receive reward and/or downlink (DL) indications, evaluate the reward and/or DL indications, and determine WTRU behavior based on the reward and/or DL indications. The WTRU may check for terminating/monitoring conditions of the online training of RL model.

For example, the WTRU may receive configuration information for the WTRU-sided RL model. The configuration information includes one or more of the following. The configuration information may include a configuration of a RL model. The configuration of the RL model may include rules for determining mode of operation (e.g., epsilon, time window, request-grant based exploration, indication based exploration, pattern-based exploration, etc.). The configuration of the RL model may include states and/or actions. The configuration of the RL model may include an exploration and/or exploitation rate. The configuration of the RL model may include a reward type and/or reward periodicity. The configuration of the RL model may include one or more RL parameters (e.g., discount factor, training hyperparameters).

The configuration information may include a configuration of WTRU behavior during an out-of-range (OOR) action. The configuration information may include a configuration of WTRU behavior for pseudo physical downlink shared channel (PDSCH) indication.

The WTRU may activate the configured online training for the RL model (e.g., based on an activation command received from the NW). The WTRU may determine exploitation or exploration mode based on the configuration of the RL model. The WTRU may determine an action based on the determined mode of operation (e.g., an exploitation action, or an exploration action). The WTRU may sent a report that indicates the action to the NW.

The WTRU may receive reward signal from the NW. In an example, the WTRU may receive a signal that carries reward feedback. For instance, the RL agent may determine a UL data channel parameter as the reward signal. In an example, the WTRU may receive an existing signal (e.g., hybrid automatic repeat request (HARQ) feedback, modulation and coding scheme (MCS) in downlink control information (DCI), beam failure, radio link failure (RLF), etc.), and the existing signal may be an indication of the reward signal. For instance, the WTRU may receive an indication to switch reward computation, or to ignore a drop on the reward. The WTRU may also receive a pseudo PDSCH DL indication and out-of-range indicator that determine the WTRU behavior.

The WTRU may evaluate the received reward. For example, if the reward is below a threshold, then the WTRU may request increased exploration from the NW. Otherwise, the WTRU keeps the exploration rate same. Alternatively, for example, the NW may indicate a new exploration rate for a certain window.

The WTRU may determine behavior as a function of a DL indication and/or an OOR indication. For example, for a link adaptation use case, if the WTRU receives a pseudo PDSCH, the WTRU may feedback acknowledgement (ACK) for all code blocks. For instance, in the link adaptation use case, the WTRU may be configured to feedback or send an ACK indication in response to a decoding failure associated with an exploration or exploitation action. Otherwise, the WTRU may use legacy acknowledgement or negative acknowledgement (ACK/NACK) methods. As another example, for a beam selection use case, if the WTRU receives a pseudo PDSCH, the WTRU may delay beam failure recovery (BFR) in case of beam failure detection (BFD). Otherwise, in this example, the WTRU may use legacy beam management techniques. As yet another example, the WTRU may update its behavior on exploration in response to one or more of the following conditions: OOR is True and legacy PDSCH indicated; and/or OOR is False and pseudo PDSCH indicated.

In an example, the WTRU may determine that an OOR condition is detected if an OOR indication received from the NW indicates that an exploration or exploitation action selected or performed by the WTRU may cause a disruption or degradation of a link between the WTRU and the NW. In another example, the WTRU may determine that the OOR condition is not detected if the received OOR indication indicates that the exploration or exploitation action selected or performed by the WTRU is less likely or unlikely to result in the disruption or degradation of the link between the WTRU and the NW.

The WTRU may check for a terminating and/or monitoring condition, e.g., using one of more of the system key performance indicators (KPIs) and intermediate KPIs specific to RL, to determine whether to terminate or deactivate training of the RL model. For example, the WTRU may monitor the rewards and/or accumulated rewards indicated in received reward signals. As another example, the WTRU may monitor an adaptation rate (e.g., convergence speed) to changing channel conditions, interference, mobility patterns, etc. As another example, the WTRU may monitor a learning overhead (or learning efficiency) of training the RL model (e.g., exploration duration/exploitation duration). As another example, the WTRU may monitor a generalization capability (e.g., RL performance under unseen data prior to fine-tuning or re-learning). As another example, the WTRU may monitor the variance of actions relative to a rate of change of channel while training the RL model.

Examples described herein include methods for characterization and/or configuration of a reward signal. Examples described herein also include WTRU methods for handling rewards and accompanied DL indications. Examples described herein also include WTRU methods for determining WTRU behavior after a WTRU receives reward signals. Examples described herein also include WTRU actions to train a WTRU-sided RL model. Using one or more of the solutions described herein advantageously enables a WTRU to handle reward functions associated with RL and to determine behavior that improves system performance.

Examples of configurations for a reward signal are described herein. Although examples in the present disclosure describe two modes, a first and second feedback mode, it should be understood that the various examples described herein are more generally applicable and/or extendable to N feedback modes, where N can be fewer or more than two modes. Furthermore, although the description/terminology used in some examples herein is based on RL algorithms, the example solutions described herein are generally applicable/extendable to any type of artificial intelligence and/or machine learning (AI/ML) algorithm. In some examples, a WTRU may be configured with a first feedback mode and a second feedback mode. For example, feedback based on first feedback mode may be assumed to achieve a minimum performance requirement. For example, the feedback based on second feedback mode may be better, same, or worse than first feedback mode. For example, the first feedback mode may be associated with exploitation phase of a Reinforcement Learning (RL) algorithm. For example, the second feedback mode may be associated with exploration phase of a RL algorithm. For example, the first feedback mode may be associated with a first AI/ML algorithm. The first AI/ML algorithm may be tested prior to deployment in the field. For example, the second feedback mode may be associated with a second AI/ML algorithm. In some examples, the second AI/ML algorithm may not be completely tested prior to deployment in the field. For example, the first feedback mode may be associated with a model trained offline with a first dataset. In this example, the second feedback mode may be associated with a model trained online with a second dataset, where, for example, the second dataset may include measurements associated with field data in real deployment.

One or more examples herein describe methods for a WTRU to determine and/or select the feedback mode, derive a feedback based on the selected feedback mode, perform transmit and/or receive actions as a function of selected feedback mode. Some examples described herein may enable the WTRU and/or the NW to determine optimal feedback at least in part based on performance of first and second feedback modes. In one or more examples herein, methods for the WTRU to receive an indication associated with a WTRU transmission are described. Such indication may be characterized as a reward signal. In some examples, the WTRU may perform one or more actions based on the reward signal. In some examples, the actions may be associated with feedback mode selection and/or parameterization thereof for subsequent transmissions.

Example configurations associated with feedback modes are described herein. A WTRU may receive configuration for online training of the WTRU-sided RL model. The received configuration may include rules for determining mode of operation. For example, the modes of operation may include an exploitation mode or an exploration mode.

A WTRU may receive configuration for an exploration rate parameter. The exploration rate parameter may be expressed as an epsilon parameter. In an example, the WTRU may be configured to determine, based on the epsilon parameter, whether to apply a first feedback mode (e.g., exploitation mode) or a second feedback mode (e.g., exploration mode). In an example, the WTRU may be configured to determine, based on the epsilon parameter, whether to select a random action or an action (e.g., an optimal action) based on previous experience. The WTRU may receive a configuration for exploration delay rate that controls how the epsilon value changes over time. The WTRU may be configured with plurality of time windows and type of feedback mode to apply within the time window. The WTRU may be configured with plurality of time windows and parameters for determining feedback mode to apply within the time window. The WTRU may be configured with resources to request for feedback mode. The WTRU may be configured with one or more patterns wherein the pattern may be associated with the type of feedback mode. The WTRU may be configured to choose feedback mode based on a preconfigured exploration/exploitation ratio. The WTRU may be configured with plurality of states and associated actions. The WTRU may be configured with criteria/condition for transition between the states.

Examples described herein include configurations associated with a reward signal. The WTRU may receive configuration for receiving reward signal. In an example, the reward signal may be explicit. For example, the WTRU may be configured to receive a new signal, indication, downlink control information and/or message from the NW. The WTRU may receive reward signal in DCI. The WTRU may receive reward signal in MAC CE. The WTRU may receive reward signal in radio resource control (RRC) reconfiguration. In some examples, the reward signal may be implicit. The WTRU may be configured to receive existing signal, indication, downlink control information and/or message from the NW. The WTRU may be configured to interpret the HARQ feedback as a reward signal. For example, the WTRU may interpret the ACK feedback as a positive reward signal. As another example, the WTRU may interpret the negative acknowledgement (NACK) feedback as a negative reward signal. The WTRU may be configured to interpret the MCS in DCI as a reward signal. For example, the WTRU may interpret an MCS above a preconfigured value as a positive reward signal. For example, the WTRU may interpret an MCS below a preconfigured value as a negative reward signal. The WTRU may be configured to interpret one or more radio resource management (RRM) and/or radio link monitoring (RLM) events as a reward signal. The WTRU may be configured to interpret Radio Link Failure (RLF) as a negative reward signal. The WTRU may be configured to interpret Beam failure as a negative reward signal. The WTRU may be configured to interpret out-of-sync (OOS) as a negative reward signal. The WTRU may be configured to interpret in-sync (IS) as a positive reward signal.

The WTRU may be configured to receive such reward signal on preconfigured time/frequency resources. The WTRU may be configured to receive reward signal periodically. The WTRU may be configured to receive reward signal based on preconfigured events. The WTRU may be configured to receive reward signal on time/frequency resource(s) at preconfigured offset from the corresponding WTRU feedback.

The reward signal may be configured to carry one or more reward value(s). For example, the WTRU may be configured with rules to map/convert/interpret the existing signal to a preconfigured reward value. For example, such mapping may be predefined. The WTRU may be configured with rules/conditions/criteria to derive the mapping between the existing signal and a reward value. Such rules/conditions/criteria may be a function of WTRU feedback. In an example, the reward signal may carry plurality of reward values that, for example, may be associated with plurality of WTRU feedback and/or transmission in the past.

Examples described herein include configurations associated with RL model training. A WTRU may receive configuration for one or more parameters associated with on-line training/finetuning of RL model. For example, the training parameters may include hyperparameter configuration. The WTRU may be configured with a discount factor. For example, the discount factor may be a scalar value between 0 and 1. The discount factor may influence the value of future rewards compared to the immediate rewards. In some examples, the WTRU may be configured with learning rate for training the RL model. The learning rate may control the step size of updates to the value estimates or policy estimates. The step size may be used to control the tradeoff between faster convergence and a stable update. In some examples, the WTRU may be configured with batch size to control the number of samples that should be considered to perform a single update to parameters. The WTRU may be configured with the total number of episodes that the WTRU should interact with the environment during training. The WTRU may be configured with regularization parameters to prevent overfitting during training. The regularization parameters may include regularization coefficient and/or a dropout rate.

Examples described herein include configurations associated with out-of-range handling. A WTRU may receive a configuration for detecting Out-Of-Range (OOR). In some examples, a WTRU may be configured to detect OOR based on explicit NW indication. For example, the WTRU may be configured to receive OOR indication in DCI, MAC control element (CE) and/or RRC signaling from the network. The WTRU may be configured to detect OOR based on implicit NW indication. For example, the WTRU may determine OOR when the reward value from the network is below a preconfigured threshold. The WTRU may determine OOR when the WTRU does not receive reward signal from the network for a preconfigured time period. The WTRU may be configured to monitor for OOR based on WTRU action selection. The WTRU may be preconfigured with a mapping between state and action set. If the WTRU selected action based on the RL model does not belong the action set of a state, the WTRU may determine that OOR is detected. In some examples, a WTRU may be configured to detect OOR based on one or more WTRU measurements. For example, when the reference signal received power (RSRP) is below a preconfigured threshold, the WTRU may determine that OOR is detected. In some examples, a WTRU may be configured to detect OOR based on the status of RLM monitoring. For example, the WTRU may determine that OOR is detected when the number of Out-Of-Sync indications (OOS) are above a threshold. The WTRU may determine that OOR is detected when the RLF is declared. For example, the WTRU may determine that OOR is detected when the beam failure is declared.

Examples described herein include configurations associated with reception of PDSCH with preconfigured format (e.g., pseudo PDSCH). The WTRU may receive a configuration to receive a PDSCH with a preconfigured format. For example, the PDSCH with preconfigured format may be referred to as pseudo PDSCH. The WTRU may be configured to train the RL model based on the reception of pseudo PDSCH. The WTRU may receive indication of pseudo PDSCH in the DCI that carries the DL grant. In an example, the WTRU may determine the pseudo PDSCH based on the format of PDSCH indicated in the DCI carrying the DL grant. The WTRU may be configured with the specific RNTI to receive DCI carrying the DL grant associated with pseudo PDSCH. The WTRU may be configured to detect OOR operation when a pseudo PDSCH is received.

The WTRU may be configured to perform one or more actions when OOR is detected and/or when pseudo PDSCH is received. For example, the WTRU may be configured to delay beam failure recovery when OOR is detected. The WTRU may be configured to drop the transport block from the pseudo PDSCH and not forward to higher layers. The WTRU may be configured to generate and/or transmit ACK for the transport block received from pseudo PDSCH.

Examples described herein include WTRU activation of a configured RL model. The WTRU may receive configuration associated with the activation of online training procedures for RL model, wherein the configuration may include one or more of the following parameters: the RL model identifier (ID) to be activated for online training, a flag to indicate the activation of online training, and/or a default RL training mode (e.g., exploration mode or exploitation mode). The exploration mode may result in random actions that are taken by the RL model to explore the actions space and to identify actions that may be beneficial on the long-term. The exploitation mode may result in deterministic actions that are selected based on some defined criteria. In an example, the WTRU may be configured to determine a RL training mode (e.g., exploitation or exploration) based on one or more configured parameters, such as: an epsilon value that controls the rate of exploration versus exploitation; a time window which can be configured as an integer value to indicate a time range (e.g., number of slots) in which a particular mode may be used; and/or a request-grant based exploration, which may be configured to indicate that the exploration mode may be used by the UE based on a request from the NW.

The WTRU may be configured to perform pattern-based exploration, at which the WTRU may determine the training mode based on a defined pattern of the activated modes over a configured period. For example, a pattern may be represented as [0,0,1,0,0,0,1] wherein ‘1’ indicates exploration and ‘0’ indicates exploitation, wherein the different patterns may be predefined, and the WTRU is configured with the pattern ID. In an example, the WTRU may determine and/or recommend the pattern ID.

The WTRU may be configured to determine an action based on the determined training mode. For example, if the training mode is exploitation, then the WTRU may select a first action that yields the highest reward/performance in the current instant but not necessarily in the long-term. If the training mode is exploration, then the WTRU may select a second action that may potentially result in a high reward value in the long-term. As an example, the first action may be a first selected MCS that is determined based on the current channel conditions and can result in acceptable throughput while the second action may be a second selected MCS that may not necessarily be the best with respect to the current transmission but may result in a better throughput in the long-term. The WTRU may be configured with resources to report the determined action to the NW, wherein the resources may be defined as a uplink control information (UCI) format, or physical uplink shared channel (PUSCH) format.

Some examples described herein include WTRU reception of a reward signal. The WTRU may be configured to receive a reward signal as a response from the NW based on the WTRU reported action. The reward signal may be an indication from the NW to reflect the quality of the WTRU reported action regardless of the training mode. For instance, the reward signal may be a feedback signal from the NW to assess the quality of the reported outcome/action of the RL model undergoing online training. The reward signal may have multiple formats, which for example, may be indicated in different ways. In some examples, the reward signal may be signaled through an implicit indication, wherein any existing signal can be used as an indication of the reward. For example, the reward signal may be a HARQ feedback wherein a positive reward translates to receiving an ACK signal. For example, the reward signal may be a transmitted MCS in DCI, wherein a positive reward translates to the transmitted MCS matching the reported MCS (e.g., output of the RL model under online training) by the WTRU, and negative otherwise. For example, the reward signal may be a beam failure indication. The WTRU may receive indication to switch the reward computation or to ignore a specific drop on the reward. For example, if the reward signal represents the measured throughput at the user exceeding a predefined threshold, the WTRU may be indicated to ignore a specific drop in the throughput performance. This may imply that the drop in the performance at the WTRU is not because of the reported action but for other reason that the NW is aware of, and hence in some transmissions the WTRU may not consider the drop in performance as a negative reward.

In some examples, the reward signal may be signaled through an explicit indication, wherein the new signal carries reward feedback. For example, the reward feedback may be a new simple Boolean DCI field with 1 indicating a positive reward and 0 indicating a negative reward.

The WTRU may receive configuration for a specific reward function with one or more parameters. For example, the parameters may be determined by WTRU measurement, for example, such as a RSRP measurement, an interference measurement, a signal to interference noise ratio (SINR) measurement, etc. For example, parameters may be associated with successful reception, for example, such as a number of ACKs, a number of DCIs (e.g., with MCS exceeding a preconfigured threshold), etc. The parameters may be associated with OOS indications. The WTRU may calculate the reward value using the preconfigured reward function and one or more measured and/or determined parameters.

The WTRU may evaluate a reward signal. The WTRU may evaluate a received reward based on received configuration information. The WTRU may compute an expected reward for a given state and/or action according to the learned RL policy. For example, the WTRU may compare the difference of received reward and expected reward against a configured threshold. If the difference is higher than a threshold, then the WTRU may increase the exploration rate or the WTRU may request the NW to increase the exploration rate. Otherwise, the WTRU may keep the exploration rate same, or decrease the exploration rate. Alternatively, for example, if the WTRU receives the reward explicitly from the NW, then the WTRU may also receive indication to increase or decrease the exploration rate. In addition, for example, the WTRU may increase or receive indication to change the exploration rate according to a window.

The WRU may update its behavior according to various use cases. The WTRU may receive a DL indication from the NW as an indication of a reward, and use the received DL indication as a basis to determine WTRU behaviour. For example, the WTRU may receive pseudo PDSCH indication from the NW. If the WTRU receives pseudo PDSCH from the NW, for example, this may indicate that the PDSCH transmission may be used for the training of UE RL agent. The WTRU may further receive an out-of-range (OOR) indicator from the NW either implicitly or explicitly. The OOR indicator determines whether an exploration action would cause disruption in the link between WTRU and NW.

For a link adaptation use case where a channel quality parameter (e.g., channel quality indicator (CQI), rank indicator (RI), and/or the like) is determined by the WTRU RL agent, the WTRU may be configured to adjust WTRU behaviour based on the DL indications. For example, the WTRU may receive a DL grant indicating legacy or pseudo PDSCH, and then receives the PDSCH. For example, if the OOR indicator was set to FALSE (e.g., or OOR indicator was set to TRUE and legacy PDSCH indicated), then the WTRU may apply the legacy PDSCH behaviour. For example, the WTRU may receive a PDSCH transmission, decode the code blocks of the PDSCH transmission, compute a reward, update the RL exploitation policy, and feed back legacy ACK/NACK code blocks. If the WTRU was indicated with pseudo PDSCH, for example, then the WTRU may apply pseudo PDSCH behavior. For example, the WTRU may receive a pseudo PDSCH transmission, decode the code blocks of the PDSCH transmission, compute a reward, update the RL exploitation policy, and feed back ACK for the code blocks.

For a beam selection use case where the best beam is determined by the WTRU RL agent, the WTRU behaviour may change based on the DL indications. The WTRU may perform beam management on configured channel state information reference signal (CSI-RS). The WTRU may receive DL grant indicating legacy or pseudo PDSCH. For example, if the OOR indicator was set to FALSE (e.g., or OOR indicator was set to TRUE and legacy PDSCH indicated), then the WTRU may apply legacy beam management procedure. For example, the WTRU may adjust the receiver (RX) beam, perform beam measurements, compute a reward, update RL exploitation policy and, initiate legacy beam failure recovery (BFR) (e.g., in case of beam failure detection (BFD)). If the WTRU was indicated with pseudo PDSCH, then the WTRU may apply pseudo beam management procedure. For example, the WTRU may adjust the RX beam, perform beam measurements, compute a reward, update RL exploitation policy, and delay BFR in case of BFD.

The WTRU may update its WTRU behavior associated with exploration. The WTRU may be configured to update behaviour of the WTRU on exploration based on the DL indications. For example, the WTRU may update its behaviour based on received OOR indications and/or PDSCH indications.

As an example, if OOR is True and a legacy PDSCH is indicated, then the WTRU may determine that the action that was tagged as OOR may correspond to an action that was not approved by the NW. Accordingly, in an example, the WTRU may decrease the probability of choosing the corresponding action for exploration. Alternatively or additionally, the WTRU may remove that corresponding action from the list of allowed actions for a time window.

As another example, if OOR is False and a pseudo PDSCH indicated, the WTRU may determine that the action which was tagged as exploitation is considered OOR by the NW. In this case, the WTRU may perform a process to update the RL policy, for example, by increasing the exploration rate and/or increasing epsilon.

As another example, if OOR is False and a legacy PDSCH indicated (e.g., or OOR True and pseudo PDSCH indicated), the WTRU may determine that the WTRU RL agent is operating consistent with expectations. Accordingly, in this example, the WTRU may be configured to delay or prevent updating the RL model and/or the exploration to exploitation rate.

Examples described herein include WTRU training and monitoring the RL model. The WTRU may receive reward signal(s) from the NW during on-line training of its RL model and monitor the model performance, for example, to check for completion of the training. The WTRU may monitor system KPI and/or intermediate KPIs specific to the ML model (e.g., RL based model) used by the WTRU. A non-exhaustive list of example KPIs may include one or more of rewards, accumulated rewards, adaptation rate, learning overhead, generalization capability, and/or variance of actions.

As an example of monitoring rewards, if the WTRU receives a reward from the NW exceeding a configured reward threshold, then the WTRU may determine that on-line RL model training (e.g., the on-line exploitation policy) is complete or that training the RL model may be (at least temporarily) deactivated. Alternatively or additionally, the WTRU may determine that the on-line RL model training is complete (e.g., and/or may be deactivated) if the reward received from the NW exceeds a configured reward threshold for a configured amount of time. In these examples, the reward may be user throughput, for instance for the link adaptation use case, and/or any other type of reward KPI.

As an example of monitoring accumulated rewards, the WTRU may be configured to receive rewards associated with a binary configuration (e.g., 1 for positive reward, and 0 for negative reward). The WTRU may be configured to calculate an accumulated reward, e.g., since the start of an online training session (e.g., by counting the number of positive rewards received so far, etc.). If the accumulated reward exceeds a configured accumulated reward threshold, for example, then the WTRU may be configured to determine that on-line RL model training (e.g., the on-line exploitation policy) is complete and/or is to be deactivated. Alternatively or additionally, the WTRU may determine that the on-line RL model training is complete (and/or may be deactivated) if the accumulated reward exceeds a configured reward threshold for a configured amount of time.

As an example of monitoring adaptation rate (e.g., convergence speed and/or convergence time), the WTRU may measure the convergence speed (e.g., or the convergence time) of the RL model and compare it to a rate of change in channel conditions. The WTRU may be configured to determine that the on-line RL model training is complete (e.g., and/or is to be deactivated) if the RL model adapts faster than the rate of change in the channel conditions, for example, when the convergence time is smaller than the coherence time of the channel. In an example, the WTRU may measure the convergence time as a product of: (i) the number of exploration actions needed until the WTRU receives a configured number of positive rewards, and/or (ii) the exploration period.

As an example of monitoring learning overhead (e.g., or learning efficiency), the WTRU may be configured to measure the learning overhead, which indicates the number of resources used for exploration compared to the number of resources used for exploitation. The resources, for example, may include duration, and/or time/frequency resources allocated to signaling associated with exploration and/or exploitation. In one example, the WTRU may be configured to measure the learning overhead as a ratio between the exploration duration and the exploitation duration. The WTRU may determine that the on-line RL learning or training is complete (e.g., and/or is to be deactivated) when the learning overhead is smaller than a configured overhead threshold such as, for example, when the WTRU adapts the exploration rate as a function of the received reward.

As an example of monitoring generalization capability, the WTRU may be configured with a set of exploration opportunities, for example to monitor how the RL model (e.g., exploitation actions/exploitation policies) operates under new channel or deployment conditions. The WTRU may determine that the RL model generalizes well (e.g., or that the generalization capability of the RL model is currently acceptable), for example, if the rate of positive rewards corresponding to exploration actions exceeds a threshold. If the WTRU determines that the RL model generalizes well with respect to unseen data, then the WTRU may determine that a monitoring and/or terminating condition is met and/or may indicate detection of the termination condition to the NW. If the WTRU determines that the RL model does not generalize well with respect to unseen data, then the WTRU may send an indication to the NW to recommend switching to online training mode.

As an example of monitoring the variance of actions relative to the rate of change of channel conditions, a WTRU may be configured to measure the variance of the actions, for example, over a monitoring window. The WTRU may be configured to determine that the RL model needs fine-tuning (e.g., or re-learning the policy), for example, if the measured variance of actions is high in relatively static or slowly changing channel conditions, or if the measured variance of actions is low in dynamic (e.g., fast changing) channel conditions. If the WTRU determines that the RL model needs fine-tuning (e.g., or policy re-learning), then the WTRU may be configured to send an indication to the NW to recommend model fine-tuning or switching to online training mode.

Example methods for reward signal design and handling for WTRU-sided reinforcement learning are described herein. The WTRU may receive configuration information for the WTRU-sided RL model. The configuration information includes one or more of the following. The configuration information may include a configuration of a RL model. The configuration of the RL model may include rules for determining mode of operation (e.g., epsilon, time window, request-grant based exploration, indication based exploration, pattern-based exploration, etc.). The configuration of the RL model may include states and/or actions. The configuration of the RL model may include an exploration and/or exploitation rate. The configuration of the RL model may include a reward type and/or reward periodicity. The configuration of the RL model may include one or more RL parameters (e.g., discount factor, training hyperparameters).

The configuration information may include a configuration of WTRU behavior during an OOR action. The configuration information may include a configuration of WTRU behavior for pseudo PDSCH indication.

The WTRU may activate the configured online training for the RL model (e.g., based on an activation command received from the NW). The WTRU may determine exploitation or exploration mode based on the configuration of the RL model. The WTRU may determine an action based on the determined mode of operation (e.g., an exploitation action, or an exploration action). The WTRU may sent a report that indicates the action to the NW.

The WTRU may receive reward signal from the NW. In an example, the WTRU may receive a signal that carries reward feedback. For instance, the RL agent may determine a UL data channel parameter as the reward signal. In an example, the WTRU may receive an existing signal (e.g., HARQ feedback, MCS in DCI, beam failure, RLF, etc.), and the existing signal may be an indication of the reward signal. For instance, the WTRU may receive an indication to switch reward computation, or to ignore a drop on the reward. The WTRU may also receive a pseudo PDSCH DL indication and out-of-range indicator that determine the WTRU behavior.

The WTRU may evaluate the received reward. For example, if the reward is below a threshold, then the WTRU may request increased exploration from the NW. Otherwise, the WTRU keeps the exploration rate same. Alternatively, for example, the NW may indicate a new exploration rate for a certain window.

The WTRU may determine behavior as a function of a DL indication and/or an OOR indication. For example, for a link adaptation use case, if the WTRU receives a pseudo PDSCH, the WTRU may feedback ACK for all code blocks. For instance, in the link adaptation use case, the WTRU may be configured to feedback or send an ACK indication in response to a decoding failure associated with an exploration or exploitation action. Otherwise, the WTRU may use legacy ACK/NACK methods. As another example, for a beam selection use case, if the WTRU receives a pseudo PDSCH, the WTRU may delay BFR in case of BFD. Otherwise, in this example, the WTRU may use legacy beam management techniques. As yet another example, the WTRU may update its behavior on exploration in response to one or more of the following conditions: OOR is True and legacy PDSCH indicated; and/or OOR is False and pseudo PDSCH indicated.

In an example, the WTRU may determine that an OOR condition is detected if an OOR indication received from the NW indicates that an exploration or exploitation action selected or performed by the WTRU may cause a disruption or degradation of a link between the WTRU and the NW. In another example, the WTRU may determine that the OOR condition is not detected if the received OOR indication indicates that the exploration or exploitation action selected or performed by the WTRU is less likely or unlikely to result in the disruption or degradation of the link between the WTRU and the NW.

The WTRU may check for a terminating and/or monitoring condition, e.g., using one of more of the system KPIs and intermediate KPIs specific to RL, to determine whether to terminate or deactivate training of the RL model. For example, the WTRU may monitor the rewards and/or accumulated rewards indicated in received reward signals. As another example, the WTRU may monitor an adaptation rate (e.g., convergence speed) to changing channel conditions, interference, mobility patterns, etc. As another example, the WTRU may monitor a learning overhead (or learning efficiency) of training the RL model (e.g., exploration duration/exploitation duration). As another example, the WTRU may monitor a generalization capability (e.g., RL performance under unseen data prior to fine-tuning or re-learning). As another example, the WTRU may monitor the variance of actions relative to a rate of change of channel while training the RL model.

1. A Wireless Transmit/Receive Unit (WTRU) comprising:
a processor configured to:
receive configuration information, wherein the configuration information comprises an indication of an exploration rate for operating according to an exploration mode or an exploitation mode, wherein the configuration information further comprises an indication of a reward type for reward signals;
send an indication of a first action associated with the exploitation mode;
receive an out-of-range (OOR) indication and an indication of a reward signal associated with the reward type;
based on the reward signal being less than a threshold and the OOR indication indicating that an OOR condition is not detected, send a request associated with the exploration mode; and
based on the reward signal being less than the threshold and the OOR indication indicating that the OOR condition is detected, adjust one or more actions to be performed by the WTRU.

2. The WTRU of claim 1, wherein the reward type is associated with an acknowledgement or negative acknowledgement (ACK/NACK) indication.

3. The WTRU of claim 1, wherein the reward type is associated with a beam indication.

4. The WTRU of claim 1, wherein the processor is configured to, in response to a beam failure detection (BFD), delay or prevent a beam failure recovery (BFR) action associated with the BFD to adjust the one or more actions.

5. The WTRU of claim 1, wherein the processor is configured to, in response to a decoding failure, send an acknowledgement (ACK) indication to adjust the one or more actions.

6. The WTRU of claim 1, wherein the indication is received via one or more of physical downlink shared channel (PDSCH) configuration information, an acknowledgement or negative acknowledgement (ACK/NACK) indication, a hybrid automatic repeat request (HARQ), or downlink control information (DCI).

7. A method performed by a Wireless Transmit/Receive Unit (WTRU), the method comprising:
receiving configuration information, wherein the configuration information comprises an indication of an exploration rate for operating according to an exploration mode or an exploitation mode, wherein the configuration information further comprises an indication of a reward type for reward signals;
sending an indication of a first action associated with the exploitation mode;
receiving an out-of-range (OOR) indication and an indication of a reward signal associated with the reward type; and
based on the reward signal being less than a threshold and the OOR indication indicating that an OOR condition is not detected, sending a request associated with the exploration mode; or
based on the reward signal being less than the threshold and the OOR indication indicating that the OOR condition is detected, adjusting one or more actions to be performed by the WTRU.

8. The method of claim 7, wherein the reward type is associated with an acknowledgement or negative acknowledgement (ACK/NACK) indication.

9. The method of claim 7, wherein the reward type is associated with a beam indication.

10. The method of claim 7, wherein adjusting the one or more actions comprises:
in response to a beam failure detection (BFD), delaying or preventing a beam failure recovery (BFR) action associated with the BFD.

11. The method of claim 7, wherein adjusting the one or more actions comprises:
in response to a decoding failure, sending an acknowledgement (ACK) indication.

12. The method of claim 7, wherein the indication is received via one or more of physical downlink shared channel (PDSCH) configuration information, an acknowledgement or negative acknowledgement (ACK/NACK) indication, a hybrid automatic repeat request (HARQ), or downlink control information (DCI).

13. The method of claim 12, further comprising determining the reward signal based on the received one or more of the PDSCH configuration information, the ACK/NACK indication, the HARQ, or the DCI.

14. The method of claim 7, wherein the request comprises a request to enter the exploration mode.

15. The method of claim 7, wherein the request comprises an indication of a second action associated with the exploration mode.

16. The method of claim 7, wherein sending the indication of the first action comprises sending an indication of one or more channel quality parameters, wherein the one or more channel quality parameters include one or more of a channel quality indicator (CQI) or a rank indicator (RI).

17. The method of claim 7, wherein sending the indication of the first action comprises sending an indication of one or more beam selection parameters.

18. The method of claim 7, further comprising activating training of the RL model, wherein sending the indication of the first action is based on the training of the RL model being activated.

19. The method of claim 18, further comprising receiving an activation command, wherein activating the training of the RL model is in response to receiving the activation command.

20. The method of claim 18, further comprising:
based on the reward signal being greater than the threshold, determining whether to deactivate training of the RL model.
